(19) United States
(12) Patent Application Publication
(10) Pub. No.: US 2020/0047983 A1
(43) Pub. Date: Feb. 13, 2020

(54) METHOD AND SYSTEM FOR PACKAGING AND TRANSPORTING FROZEN OYSTERS ON THE HALF SHELL

(71) Applicant: Mark Maynard, SR., Melbourne, FL (US)

(72) Inventor: Mark Maynard, SR., Melbourne, FL (US)

(21) Appl. No.: 16/102,688

(22) Filed: Aug. 13, 2018

(51) Int. Cl. B65D 85/50; B65B 25/06; A23L 17/50; B65D 81/20; B65D 21/02

(52) U.S. Cl. CPC B65D 85/50; B65B 25/062; A22C 29/04; B65D 81/2007; B65D 21/02; A23L 17/50

(57) ABSTRACT

A method is provided for packaging frozen oysters on a half shell in a container. Each frozen oyster on the half shell comprises oyster meat on a round shell. The method includes the step of positioning the frozen oysters within the container in an inverted orientation such that oyster meat of the frozen oysters faces a bottom of the container and the round shell of the frozen oysters faces an opening in a top of the container.

### FIELD OF THE INVENTION

The present invention relates to oysters, and more particularly, to a method and system for packaging and transporting frozen oysters on the half shell.

### BACKGROUND

Frozen half shell oysters started becoming popular in 2001, 2002. They do not spoil and require no shuckers at restaurants to open. Traditionally, to produce frozen half shell oysters each live oyster must be opened one at a time (shucked) by hand, using many workers with sharp knifes or grinders. This is a very labor intense process, having to use skilled workers and is expensive. Once the oysters are opened on the half shell they are quick frozen using small CO₂ or nitrogen tunnel freezers. Then they are sold to restaurants and food establishments for easy to eat half shell oysters.

FIG. 10A is a photograph that illustrates an example of a conventional layer pack 300 that is used to package and transport half-shell oysters. Additionally, FIG. 10B is a photograph that illustrates an example of a conventional bulk pack 302 that is used to package and transport half-shell oysters. These conventional layer packs 300 and bulk packs 302 are not user friendly. The packs 300, 302 are frozen during shipment to a location (e.g. restaurant, hotel) where oysters are served and upon thawing of the packs 300, 302 at the location, the shelf life of the oysters is a maximum of about 12 hours. Thus, the oysters must be served within 12 hours of being thawed at the location since after 12 hours from thawing the oysters, degradation of the half shell oyster comprises quality, texture and moisture, making the half shell oysters not servable.

### SUMMARY OF THE INVENTION

The inventor identified various drawbacks with the conventional frozen oyster processing methods, i.e., the conventional layer packs 300 and bulk packs 302 depicted in FIGS. 10A and 10B. For example, the inventor recognized that when half shell oysters are packaged and transported using these conventional packs 300, 302, they must be served within 12 hours of thawing the oysters. This severely limits the time window within which the half oysters must be served at the restaurant, hotel or similar facility, after the layer pack or bulk pack is received and the oysters are thawed.

The inventor recognized that since the conventional layer packs and bulk packs in FIGS. 10A and 10B do not feature any vacuum seal, there is no restriction on the extent to which the half shell oysters interact with the atmosphere, which accelerates the degradation of the oysters. The inventor further recognized that any such vacuum seal film applied to an oyster package would need to be specifically sized and selected to ensure that the edge of the half shell does not puncture the film when in the inverted orientation and thus break the vacuum seal. Such a vacuum seal film would advantageously reduce or eliminate the extent to which the half shell oysters interact with the atmosphere prior to and after the thawing of the oysters, thereby extending the time window that the oysters are fresh and capable of being served.

The inventor further recognized that the conventional layer packs 300 and bulk packs 302 in FIGS. 10A and 10B orient the half shell oysters in an upright orientation, i.e. where the meat on the half shell oyster faces toward the top of the container and/or away from a direction of gravity. Consequently, the inventor recognized that the half shell oysters that are packaged in the conventional layer packs and bulk packs are not stored so that the meat on the half shell is permitted to soak in its natural juice. Thus, to alleviate this noted drawback, the inventor introduced a step in the packaging process where the half shell oysters are sprayed with a salt glaze and the half shell oysters are then oriented in an inverted orientation in the tray so that the meat on the half shell faces a bottom of the container and/or faces a direction of gravity, so that the meat on the half shell can soak in its natural juices. This advantageously extended the time after thawing that the half shell oysters remain fresh for serving from 12 hours (with the prior art packaging methods) to 72 hours with the packaging method described herein. Food Safety Net Services (FSNS)® certified that the inventor's packaging process maintained the oysters freshness over a 72 hour extended window. The FSNS® issued a Final Report Number 18-099851 and 18-122090 that certify this 72 hour extended window, and said Final Report is incorporated by reference herein to the extent is does not contradict any of the language herein.

In one embodiment, a method is provided for packaging frozen oysters on a half shell in a container. Each frozen oyster on the half shell comprises oyster meat on a round shell. The method includes the step of positioning the frozen oysters within the container in an inverted orientation such that oyster meat of the frozen oysters faces a bottom of the container and the round shell of the frozen oysters faces an opening in a top of the container.

In another embodiment, an assembly is provided for packaging and transporting oysters on a half shell. Each frozen oyster on the half shell includes oyster meat on a round shell. The assembly includes a tray including a bottom and a top with a vacuum seal applied along the top of the tray to define a cavity between the bottom and the vacuum seal. The cavity is configured to position the oysters on the half shell so that the oyster meat faces the vacuum seal and the half shell faces the bottom. The assembly also includes a container including a bottom and a top, where the tray is positioned in the container with the vacuum seal facing the bottom of the container and the bottom of the tray facing the top of the container so to orient the oysters on the half shell in an inverted orientation within the container such that the oyster meat faces the bottom of the container and the half shell faces the opening in the top of the container.

In yet another embodiment, an assembly is provided for packaging and transporting oysters on the half shell using the method discussed above. The assembly includes the container and a plurality of trays positioned in the container so that the frozen oysters in each tray are oriented in the inverted orientation within the container.

In yet another embodiment, a method is provided for serving oysters from the assembly discussed above. The method includes thawing the oysters by storing the assembly in a cooler at a thawing temperature for a predetermined time. The method further includes removing one or more trays from the container, after the predetermined time and when an amount of oysters are to be served. The method further includes orienting the one or more trays so that the oysters are in an upright orientation such that the oyster meat faces upward and the round shell faces downward. The method further includes removing the vacuum seal along the top of the tray to expose the amount of oysters to be served. The method further includes removing the amount of oysters to be served from the tray.

Still other aspects, features, and advantages are readily apparent from the following detailed description, simply by illustrating a number of particular embodiments and implementations, including the best mode contemplated for carrying out the invention. Other embodiments are also capable of other and different features and advantages, and its several details can be modified in various obvious respects, all without departing from the spirit and scope of the invention. Accordingly, the drawings and description are to be regarded as illustrative in nature, and not as restrictive.

The novel features which are considered characteristics of certain embodiments of the present invention are set forth in the appended claims. Embodiments of the invention relating to construction and method of operation embodiments, together with additional advantages thereof, will be best understood from the following description of the specific embodiments when read and understood in connection with the accompanying drawings.

### BRIEF DESCRIPTION OF THE DRAWINGS

Embodiments are illustrated by way of example, and not by way of limitation, in the figures of the accompanying drawings in which like reference numerals refer to similar elements and in which:

FIG. 1 is an image that illustrates one example of a diagrammatic perspective view showing the various steps of the present invention, according to an embodiment;

FIG. 2 is an image that illustrates one example of a diagrammatic elevational view taken in the direction of arrow 3 in FIG. 2 of a portion thereof, according to an embodiment;

FIG. 3 is an image that illustrates one example of a diagrammatic elevational view taken in the direction of arrow 4 in FIG. 2 of a portion thereof, according to an embodiment; and

FIG. 4 is an image that illustrates one example of a diagrammatic elevational view taken in the direction of arrow 5 in FIG. 2 of a portion thereof, according to an embodiment.

FIG. 5A is an image that illustrates one example of a diagrammatic representation of a flowchart of an embodiment of the present invention;

FIG. 5B is an image that illustrates one example of a diagrammatic representation of a flowchart of an embodiment of the present invention;

FIG. 6A is an image that illustrates an example of a top view of a tray to package oysters, according to an embodiment;

FIG. 6B is an image that illustrates an example of a side view of the tray of FIG. 6A, according to an embodiment;

FIG. 6C is an image that illustrates an example of a bottom perspective view of the tray of FIG. 6A, according to an embodiment;

FIG. 7A is an image that illustrates an example of a top view of a tray to package oysters, according to an embodiment;

FIG. 7B is an image that illustrates an example of a side view of the tray of FIG. 6A, according to an embodiment;

FIG. 7C is an image that illustrates an example of a bottom perspective view of the tray of FIG. 6A, according to an embodiment;

FIG. 8A is a block diagram that illustrates an example of a freezer and a cold room used to store the tray of FIG. 6A, according to an embodiment;

FIG. 8B is an image that illustrates an example of a machine to apply a vacuum seal film over the tray of FIG. 6A, according to an embodiment;

FIG. 8C is an image that illustrates an example of the vacuum skin machine of FIG. 8B, according to an embodiment;

FIG. 9A is a photograph that illustrates an example of a top view of the half shell oysters packaged within the tray of FIG. 6A, according to an embodiment;

FIG. 9B is a photograph that illustrates an example of the packed tray of FIG. 9A stored in a container in an inverted orientation, according to an embodiment;

FIG. 9C is an image that illustrates a cross-section image taken along the line 9C-9C in FIG. 9B, according to an embodiment;

FIG. 9D is a photograph that illustrates an example of one oyster packaged within one compartment of the tray of FIG. 9A, according to an embodiment;

FIG. 9E is an image that illustrates one example of unfolded material used to form the container of FIG. 9B, according to an embodiment;

FIG. 9F is a block diagram that illustrates one example of multiple containers depicted in FIG. 9B stacked in a shipping container and enclosed by refrigerant, according to an embodiment;

FIG. 10A is a photograph that illustrates an example of a conventional layer pack that is used to package and transport half-shell oysters; and

FIG. 10B is a photograph that illustrates an example of a conventional bulk pack that is used to package and transport half-shell oysters.

### DETAILED DESCRIPTION

A method and apparatus are described for packaging and transporting frozen oysters on the half shell. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements at the time of this writing. Furthermore, unless otherwise clear from the context, a numerical value presented herein has an implied precision given by the least significant digit. Thus a value 1.1 implies a value from 1.05 to 1.15. The term “about” is used to indicate a broader range centered on the given value, and unless otherwise clear from the context implies a broader rang around the least significant digit, such as “about 1.1” implies a range from 1.0 to 1.2. If the least significant digit is unclear, then the term “about” implies a factor of two, e.g., “about X” implies a value in the range from 0.5X to 2X, for example, about 100 implies a value in a range from 50 to 200. Moreover, all ranges disclosed herein are to be understood to encompass any and all sub-ranges subsumed therein. For example, a range of “less than 10” for a positive only parameter can include any and all sub-ranges between (and including) the minimum value of zero and the maximum value of 10, that is, any and all sub-ranges having a minimum value of equal to or greater than zero and a maximum value of equal to or less than 10, e.g., 1 to 4.

Some embodiments of the invention are described below in the context of packaging frozen oysters, including packaging frozen oysters on a half shell for transport. In other embodiments, the invention is described below in the context of packaging any frozen clam on a half shell. In an example embodiment, the frozen oysters on the half shell are transported to a second location, (e.g. restaurant, hotel, etc.) where they are served. Other embodiments of the invention are described in the context of the assembly that is used to package and transport the oysters. Still other embodiments of the invention are described in the context of a method for serving the oysters from the package assembly after it is shipped to a location (e.g. restaurant, hotel, etc.) to be served.

In an embodiment, the term “inverted orientation” is defined herein to mean an orientation of a half oyster where the meat on the half shell is oriented towards a bottom of a container and/or in a direction of gravity and/or more proximate to the gravitational core of the Earth than the half shell of the oyster and where the half shell is oriented towards a top of the container and/or in a direction opposite to the direction of gravity and/or less proximate to the gravitational core of the Earth than the meat on the half shell. Thus, in one example embodiment, the “inverted orientation” is defined within the frame of reference of the container so that the meat on the half shell faces the bottom of the container, the half shell faces the top of the container, where the top of the container includes an opening through which the oysters are inserted into the container and where the container is configured to be oriented with the bottom of the container below the top of the container during shipment and/or with the container positioned with the bottom of the container on a surface during shipment. In another example embodiment, the “inverted orientation” is defined within the frame of reference of the Earth's gravitational field, so that the meat on the half shell faces the direction of gravity and/or is more proximate to the Earth's gravitational core than the half shell. In another embodiment, an “upright orientation” is defined as an inverse of the “inverted orientation” such that the meat on the half shell is oriented opposite to the direction of gravity and/or less proximate to the gravitational core of the Earth than the half shell.

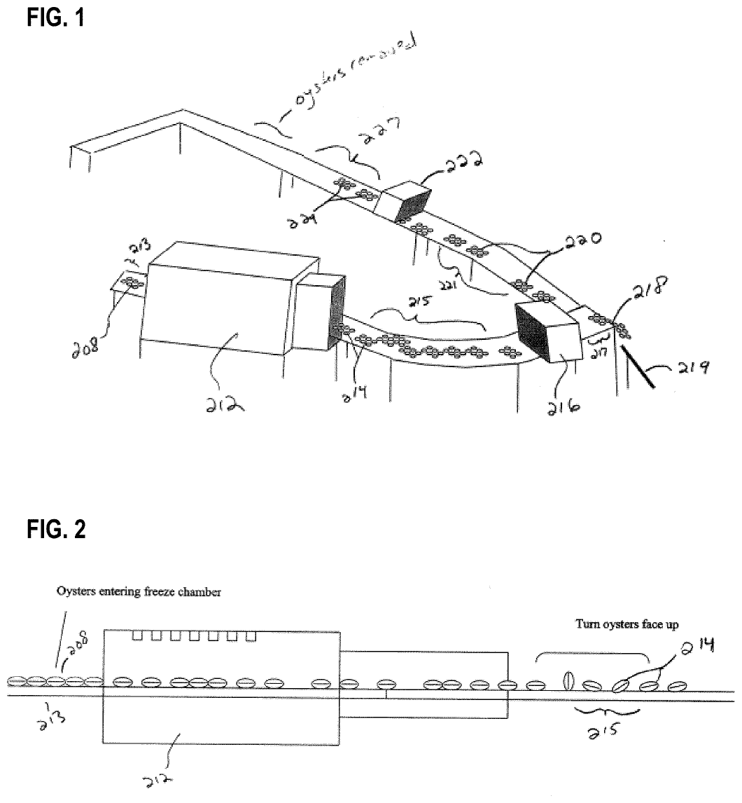

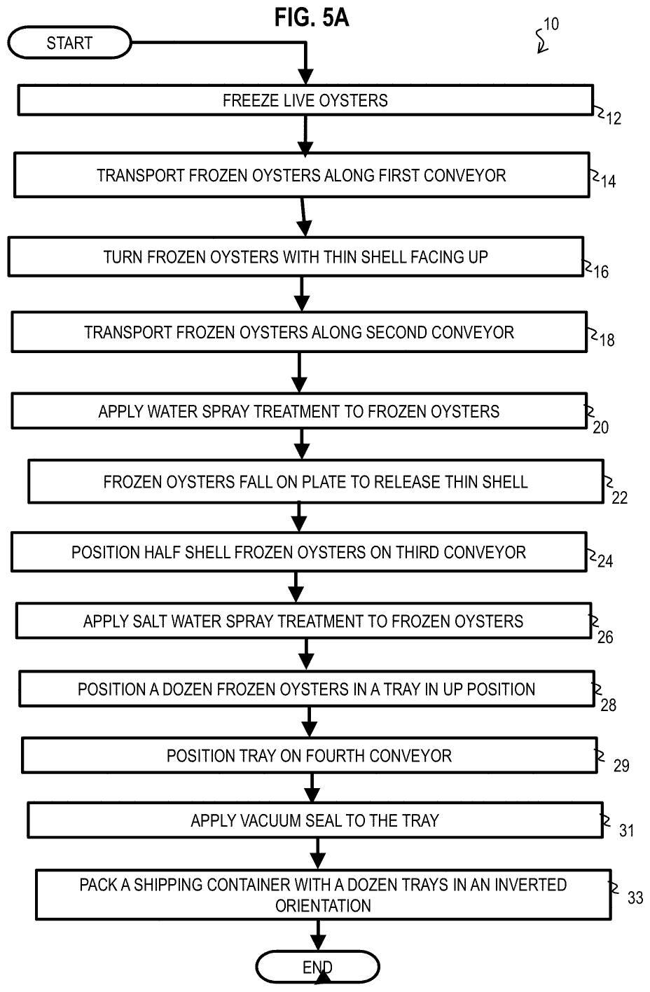

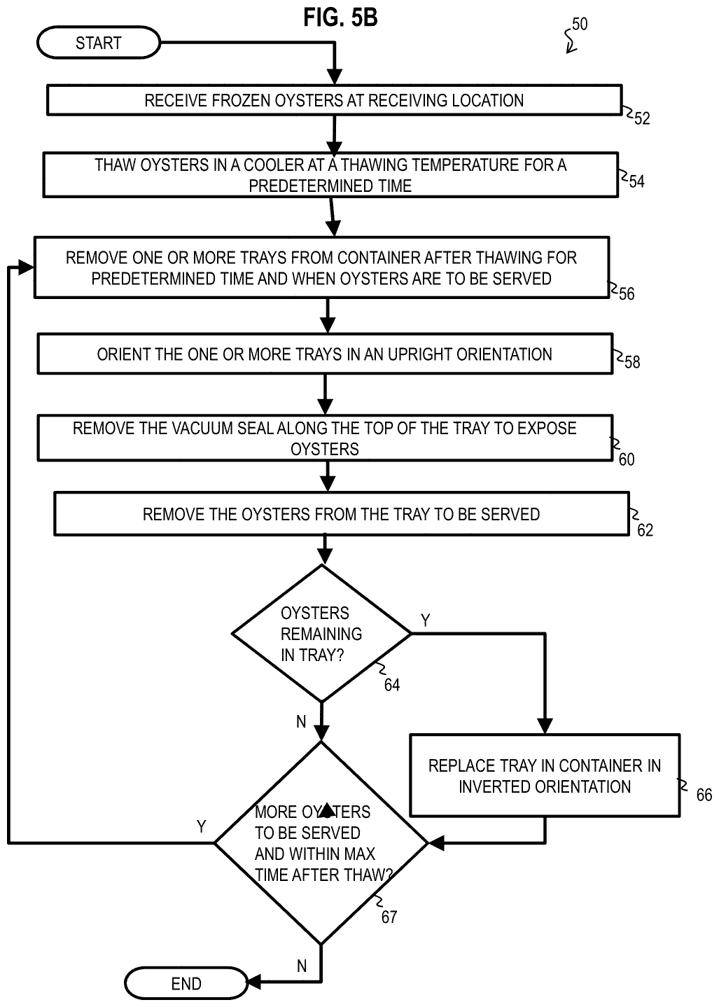

Referring now to the figures, in which like numerals indicate like parts, and particularly to FIGS. 1 through 9, including FIGS. 5A-5B which are diagrammatic representations of flowcharts of an embodiment of the present invention; a diagrammatic view showing the complete structure of the present invention; a diagrammatic elevational view taken in the direction of arrow 3 in FIG. 2 of a portion thereof; a diagrammatic elevational view taken in the direction of arrow 4 in FIG. 2 of a portion thereof; and a diagrammatic elevational view taken in the direction of arrow 5 in FIG. 2 of a portion thereof, and as such, will be discussed with reference thereto.

Turning first to FIG. 1, a system embodiment is shown that comprises a cryogenic freezing apparatus 212 for freezing oysters 208 to an appropriate temperature in order to crack the hinge of the oyster. Oysters are loaded onto a first portion of a conveyor 213 which carries fresh live oysters 208 into the freezing apparatus 212. Frozen oysters 214 are transported out of the freezing apparatus 212 via a conveyor second portion 215. The second portion 215 is accessible thereby allowing users to turn the oysters flat side up. Alternatively, the oysters are turned flat side up before entering the freezing apparatus 212. The frozen oysters 214 are transported to a water tunnel 216 that subjects the oysters to a water treatment (spray or shower) predominantly on one side of the oyster at a predetermined time. In an alternative embodiment, the water treatment is substituted by another form of thermal treatment such as heated gas (e.g. heated air) or an oven (e.g. oven having a heating element or some other means of dispensing localized heat). A third conveyor portion 217 transports the frozen oysters 214 from the water tunnel 216 to a precipice 218. The frozen oysters 214 are dropped over the precipice 218 and dropped onto an inclined percussing apparatus 219. Dropping onto the inclined percussing apparatus 219 causes the oyster shell given the water treatment (e.g. flat shell) to knock off. The opened, frozen oysters 220 are delivered to a fourth conveyor portion 221 whereby personnel turn them with the meat facing up. The opened, frozen oysters are transported to a glazing tunnel 222 which showers the oysters with a salt solution. Because the oysters are still at extremely cold temperatures, the salt solution freezes over the opened, frozen oysters 220 thereby creating a protective glaze. A fifth conveyor portion 227 transports glazed oysters 229 from the glazing tunnel 222 to a removing area.

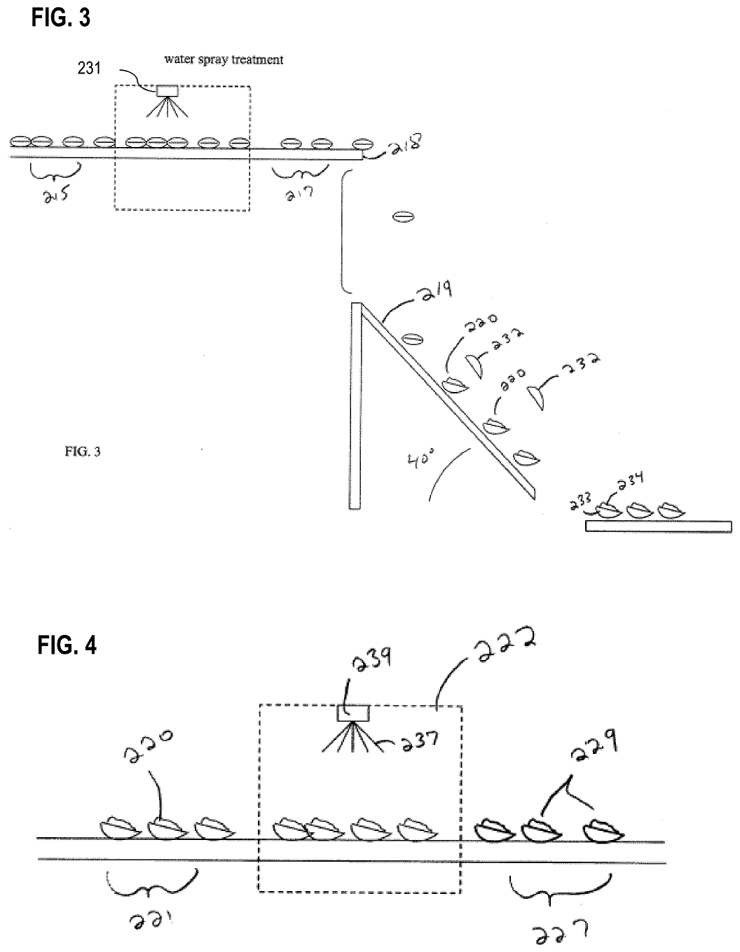

FIG. 2 shows a side view of the first conveyor portion 213 with fresh oysters 208 thereon, the freezing apparatus 212 and second conveyor portion 215. The frozen oysters 214 are turned flat side up before entering the water tunnel 216 as shown in FIG. 3.

FIG. 3 shows a side view of the second conveyor portion 215, the water tunnel 216, the third conveyor portion 217, the precipice 218 and the inclined percussing apparatus 219. The frozen oysters 214 are treated with water via spray nozzle 231. The third conveyor portion 217 transports the oysters from the water tunnel 216 to precipice 218 whereby the oysters fall onto the inclined percussing apparatus 219 causing the flat shell 232 to knock off from the round shell 233 and oyster meat 234. The round shell and oyster meat provide open, frozen oysters 220.

FIG. 4 shows a side view of the fourth conveyor portion 221, glazing tunnel 222 and fifth conveyor portion 227. The opened frozen oysters 220 are transported to the glazing tunnel 222 and subjected to a salt solution 237 via spray nozzle 239. The salt solution 237 freezes over the opened frozen oysters 220 to form glazed oysters 229.

Turning to FIG. 5A, a flowchart of a method embodiment 10 for producing frozen oysters on the half shell is shown. Although steps are depicted in FIG. 5A, and in subsequent flowchart FIG. 5B, as integral steps in a particular order for purposes of illustration, in other embodiments, one or more steps, or portions thereof, are performed in a different order, or overlapping in time, in series or in parallel, or are omitted, or one or more additional steps are added, or the method is changed in some combination of ways.

In a first step 12 live oysters in the shell, (not opened, not shucked) are placed in a nitrogen tunnel freezer 212 where liquid nitrogen is released through a series of manifolds and then jet sprays. The liquid nitrogen is about −320 degrees below zero or in a range from about −280 degrees to about −350 degrees below zero as a liquid. When the liquid nitrogen is released in the tunnel 212 it turns into a super cold gas and causes the oysters to become frozen.

The live oysters in the shells travel on a first conveyor at a speed of about 3.15 feet per minute or in a range from about 2 feet per minute to about 5 feet per minute at a temperature of about −120 degrees F. below zero or in a range from about −100 degrees F. below zero to about −150 degrees F. below zero. Total time in the tunnel is about 5.54 minutes or in a range from about 4 minutes to about 7 minutes. In this first step the oysters become completely frozen and pressure from water expansion in the shells causes the hinges in the back of the oysters to break open.

Failure test in step one. Live oysters placed in the same tunnel at −100 degrees below zero for the same time will not cause the hinges in the back of the oysters to break. Many tests with many different temperatures and times have resulted in failure. In addition, live oysters that travel at the same speed at −150 degrees will cause the hinges to break open, but the meat once thawed is so completely damaged it is un-salable.

In a second step 14 the oysters 214 exit the tunnel 212 with an outside shell temperature of about −60 to about −80 degrees F. as they move onto a second conveyor 215. The oysters 214 stay on the second conveyor 215 for the next three steps.

In a third step 16 each oyster 214 are turned facing in an up position. The up position is the thin side of the oyster up and the cup side of the oyster down.

In a fourth step 18 the oysters 214 ride on the second conveyor 215 with the shells turned up for a minimum period (e.g. about 3 minutes). In an example embodiment, the 3 minute travel time to the next step will allow all the oysters to acclimate to temperatures that are close in range (e.g. about 0 degrees). The inventor has found that the oyster meat 234 will break apart if not enough acclimation time is provided.

In a fifth step 20 the oysters 214 now frozen in their original shells and all near about 0 degrees F. and facing up enter into a water tunnel 216 that sprays the top shells with water. The temperature of the water is in a range from about 65 degrees F. to about 70 degrees F. The oysters 214 remain in this tunnel 216 for a time period in a range from about 1 minute to about 2 minutes and more specifically from about 1 minute 15 seconds to about 1 minute 20 seconds depending on the size of the oysters 214 being produced. The inventor has found that too little time in the water tunnel 216 will result in a failure of the top shells to come off, with broken oyster meats. Too long will cause thawed not frozen half shell oysters.

In a sixth step 22 the oysters 214 exit the water tunnel 216 an immediately fall from the second conveyor 217 for a distance of about 5 feet or in a range from about 4 feet to about 6 feet onto a stainless steel plate that is about ⅜ of an inch thick or in a range from about ⅛ inch think to about ¾ inch thick and setting at an angle of about 40 degrees or in a range from about 30 degrees to about 50 degrees. In this step, one of the two abductor muscles that holds the shells on will fail and release one shell from the oysters. Thermal shock has occurred in this step. Only one of two shells will release leaving perfect frozen half shell oysters.

In a seventh step 24 the oysters 220 will fall onto a third conveyor 221 that will bring them up to table level. The oysters 220 continue to travel at this level and are turned up by hand so that the oysters 220 with meat 234 and one shell 233 are exposed.

In an eighth step 26 the frozen oysters on the half shell pass through another water tunnel 222 where they are sprayed with a water spray 239 having a temperature of about 38 degrees F. or in a range from about 32 degrees F. to about 45 degrees F. and containing about 30 parts per thousand salt or in a range from about 1 to about 50 parts per thousand salt. The temperature of the oyster meat 234 is about 25 degrees or in a range from about 15 degrees to about 30 degrees F. allowing the water to freeze on the top meat. This allows a frozen water glaze to protect the meat from freezer burn and at the same time adding a flavor of salt. Salt flavor in half shell oysters is the most desired taste.

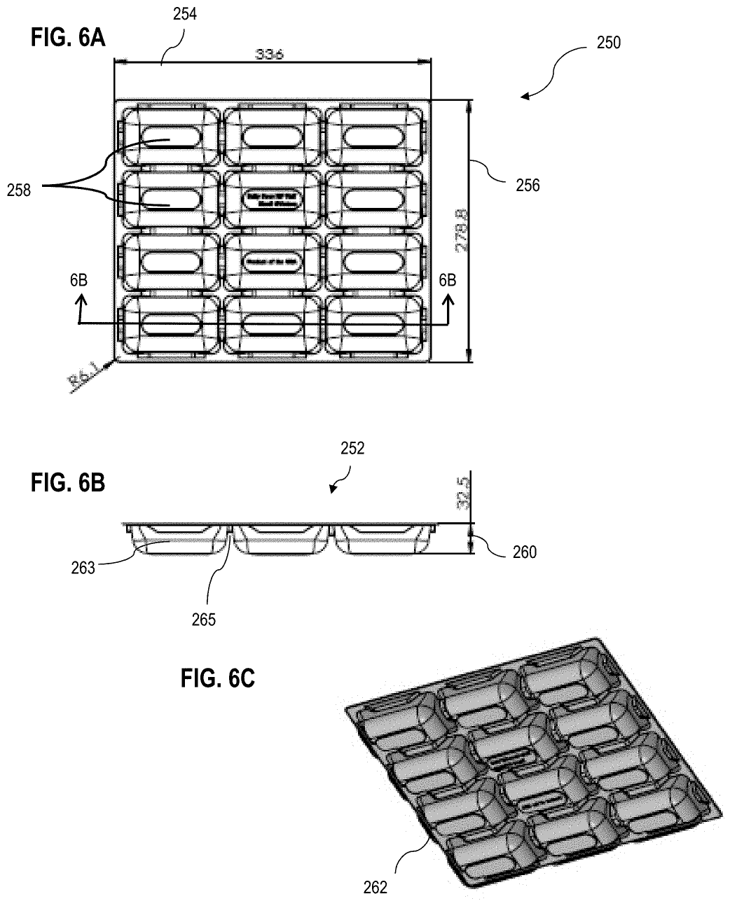

In a ninth step 28 the oysters 229 travel down the third conveyor 227. The oysters 229 with meat 234 and one shell 233 exposed are taken from the third conveyor 227 and placed in special plastic shaped trays 250 that hold a fixed amount (e.g. one dozen) of oysters 229 in the up position. FIGS. 6A-6C depict one example of a tray 250 including a plurality of compartments 258 (e.g. a dozen) separated by a divider 265. In an embodiment, the tray 250 has a dozen compartments 258 in a 3×4 arrangement. In another embodiment, the length 254 of the tray 250 is adjusted based on a combined length of a first number (e.g. 3) of oysters 229, so the length 254 is slightly greater than the combined length of the first number of oysters 229. In an example embodiment, the length 254 is about 336 mm or in a range from about 300 mm to about 400 mm. In another embodiment, the width 256 of the tray is adjusted based on a combined width of a second number (e.g. 4) of oysters 229, so the width 256 is slightly greater than the combined width of the second number of oysters 229. In an example embodiment, the width 256 is about 279 mm or in a range from about 250 mm to about 350 mm. Although FIG. 6A is depicted for a 3×4 arrangement for the length 254 and width 256, the length 254 and width 256 can be adjusted based on any A×B arrangement where A is the first number of oysters 229 and B is the second number of oysters 229.

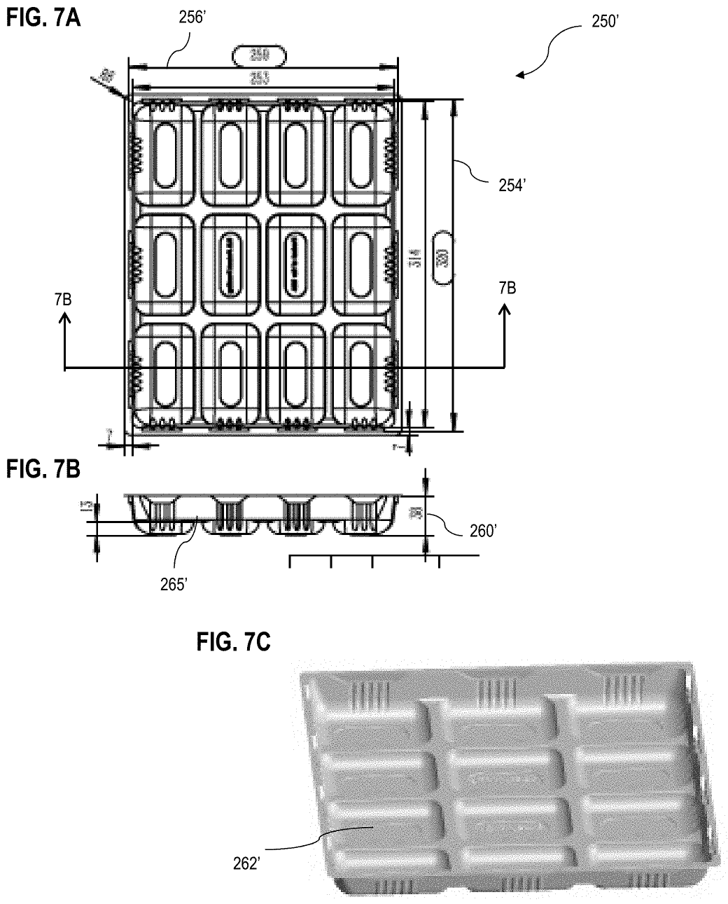

A cavity 263 is defined in each compartment 258 between a bottom 262 of the tray 250 and a vacuum seal film 251 (discussed below), where the cavity 263 is sized to receive a respective oyster 229. In some embodiments, the cavity 263 is sized to receive multiple oysters 229. In an embodiment, a height 260 of the cavity 263 is adjusted based on a height of the oyster 229 such that it is slightly greater than the height of the oyster 229 and is about 33 mm or in a range from about 30 mm and 40 mm. FIGS. 7A-7C depict another embodiment of a tray 250′ that is similar to the tray 250 except that the tray 250′ features different dimensions and the divider 265′ is shorter, i.e. does not extend as far into the cavity 263 as the divider 265 in FIGS. 6A-6C.

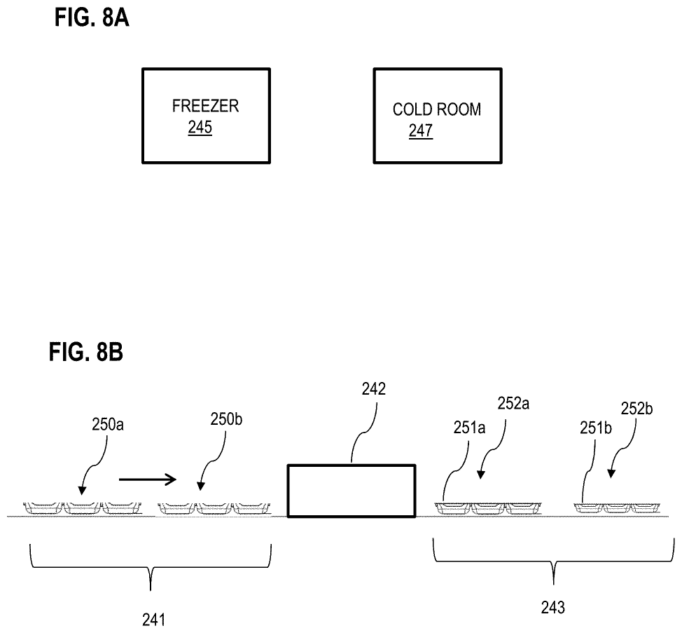

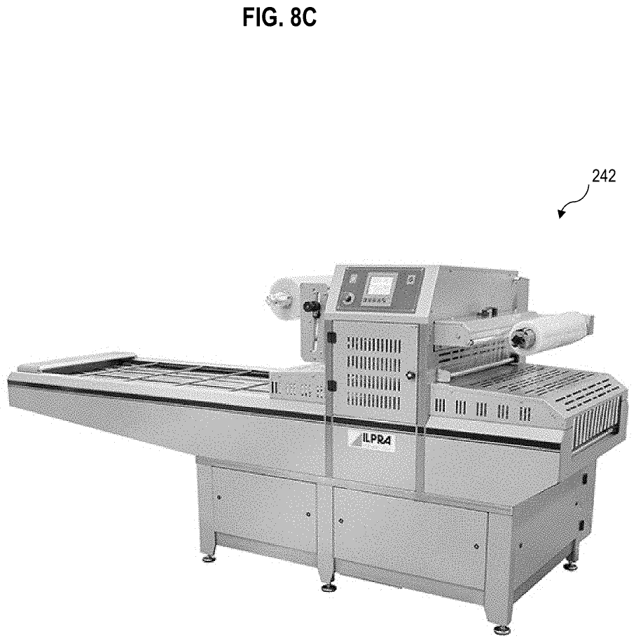

During step 28, after the oysters 229 are placed in the compartments 258 of the tray 250, the empty shells continue on and exit the building to a waste area. In one embodiment, in step 28 a fixed amount (e.g. fourteen) of trays 250 are filled with oysters 229 and are placed in a master container. In another embodiment, in step 28, a fixed amount (e.g. twenty five) of the master containers are stacked into one pallet and the pallet is stored in a freezer 245 (FIG. 8B) at a freezing temperature (e.g. about 0 degrees F. or in a range from about −20 degrees F. to about 32 degrees F.). In an embodiment, in step 28 the trays and/or master containers are stored in the freezer 245 for a certain time period (e.g. 1-2 days) until the method proceeds to the next step 29. In other embodiments, the trays are not frozen in the freezer 245 and instead the method 10 proceeds directly to step 29.

In a tenth step 29, the trays and/or master containers are removed from the freezer 245 and moved to a cold room 247 (FIG. 8B) with a temperature that is greater than the freezing temperature in the freezer 245. In an embodiment, the temperature in the cold room 247 is about 45 degrees F. or in a range from about 32 degrees F. to about 50 degrees F. FIG. 8B depicts an embodiment of a first conveyor 241 incident to a vacuum skin machine 242 and a second conveyor 243 away from the vacuum skin machine 242. In one embodiment, the vacuum skin machine 242 is a Foodpack Speedy 2 EMEC®, model number EP10154 manufactured by ILPRA® of Mortara Italy. FIG. 8C is an image that illustrates an example of the ILPRA® vacuum skin machine 242 of FIG. 8B, according to an embodiment. In an example embodiment, the vacuum skin machine 242 includes one or more parameters including a length in a range of about 3000-4000 mm, a width in range of about 1000-2000 mm and a height in a range of about 1000-2000 mm; a weight in a range of about 500-1500 kg; an installed power of about 13 kW; an air consumption of about 4-8 bar-lt/ciclo; a maximum tray size of about 640 mm length×330 mm width×135 mm height; a sealing area of about 640 mm×330 mm (1 cycle); a length of loading area of about 4 steps and a maximum diameter of reels in a range from about 200-400 mm.

In an embodiment, as depicted in FIG. 8B, in step 29 the trays 250a, 250b are positioned on the first conveyor 241 so that the trays are each guided into the vacuum skin machine 242 so that a vacuum seal film 251a, 251b is applied along the top of each tray in step 31. In one embodiment, in step 31 one or more settings of the vacuum skin machine 242 are adjusted, to provide various advantages in the packaging and storing of the oysters 229. In one example embodiment, the vacuum setting of the vacuum skin machine 242 is adjusted to be about 85% or in a range from about 75% to about 95%. This vacuum setting advantageously minimizes an extent to which the atmosphere reacts with the oysters 229 during the freezing, thawing and post-thawing time periods, thereby extending the time period during which the oysters 229 are fresh to serve. In an example embodiment, trays 250 pass through the vacuum skin machine 242 at a rate of about 6 to 8 trays per minute or about 4 to 10 trays per minute.

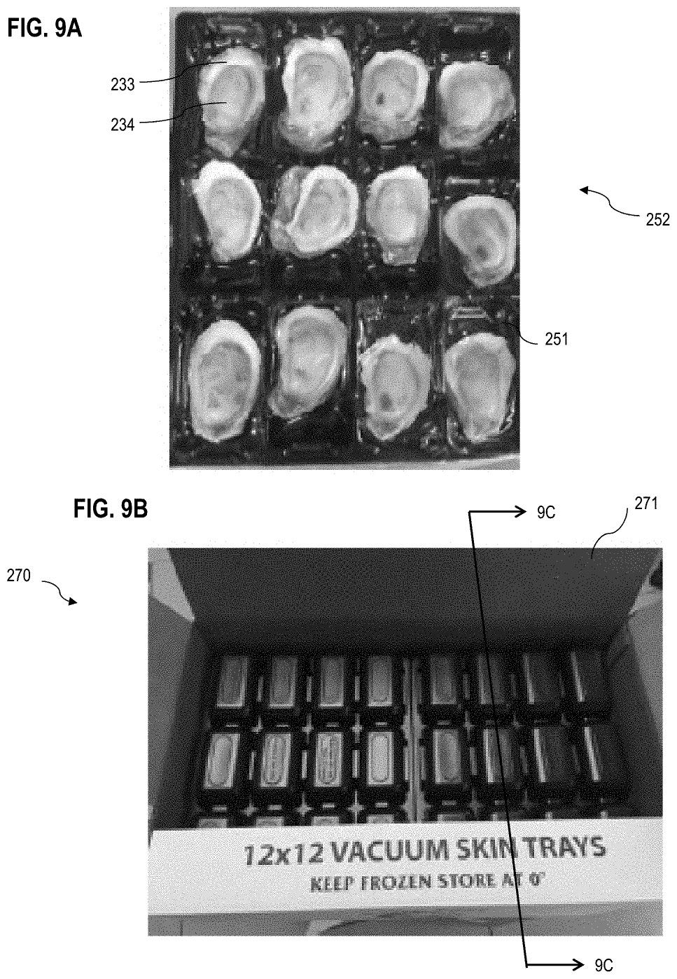

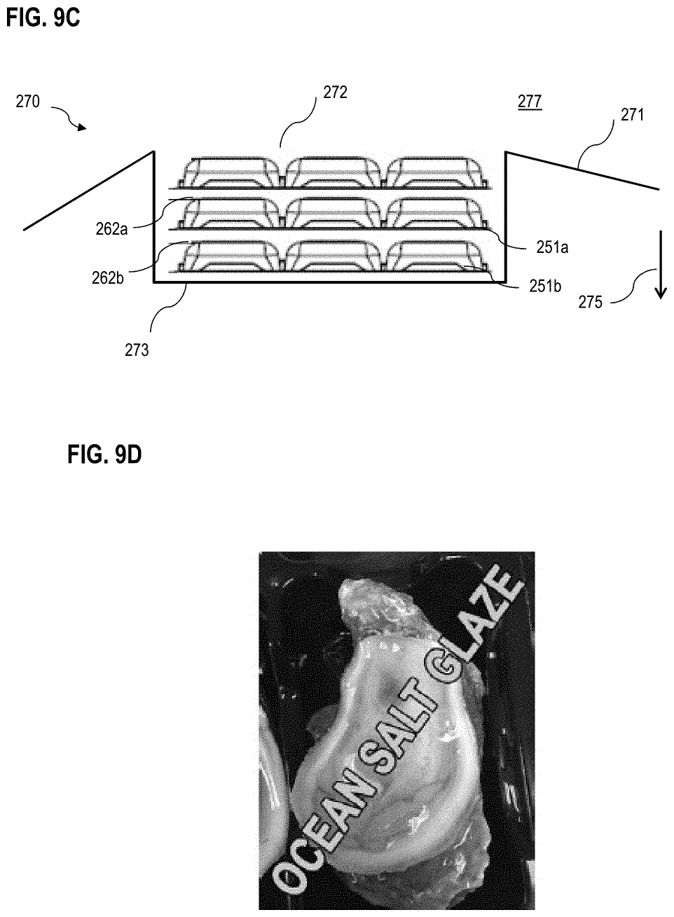

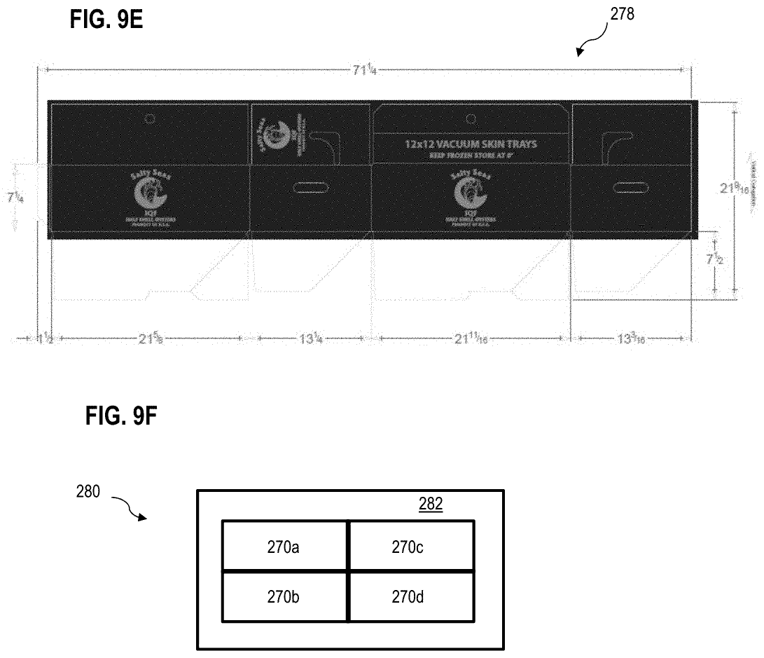

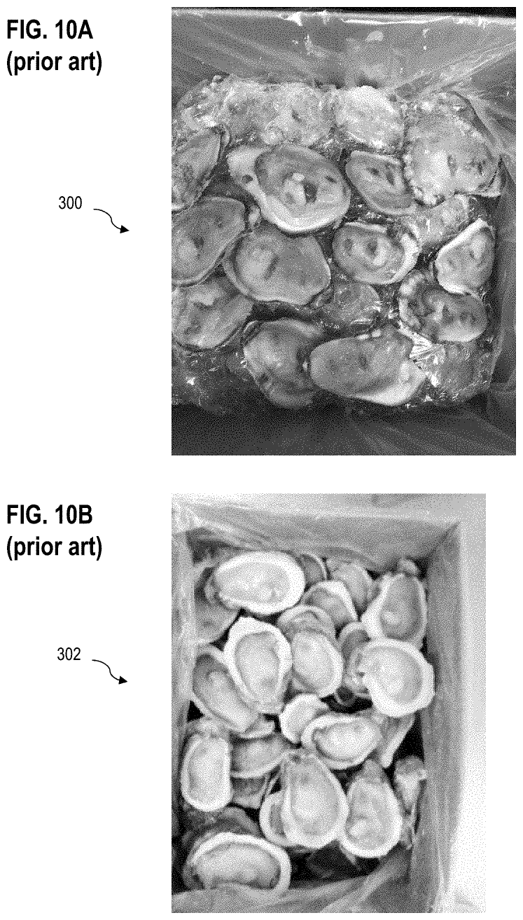

In another example embodiment, the temperature of the film 251 prior to application is set to be about 190 degrees C. or in a range from about 150 degrees C. to about 220 degrees C. In yet another example embodiment, the trays 250a, 250b are made of a thermoplastic polymer material (e.g. poly propylene with a poly ethylene surface) to encourage the applied film 251 to bond enough to hold the vacuum while still permitting a customer to peel off the film 251 when the oysters 229 are ready to serve. In yet another example embodiment, a thickness of the film 251 is selected to be about 6 mil (e.g. 1 mil= 1/1000 inch) or in a range from about 4 mil to about 8 mil. This specific thickness of the film 251 is selected in order to ensure that the edge of the half shell does not puncture the film 251 during or after the thawing process, thereby ensuring that the vacuum remains intact and extending the time period that the oysters 229 remain fresh after the thawing of the oyster 229. As a result of step 31, the resulting sealed trays 252a, 252b with vacuum seal films 251a, 251b over the top of the trays are directed along the second conveyor 243 out from the skinning machine 242. Although steps 29, 31 discuss that the vacuum skin machine 242 and conveyors 241, 243 are used to apply the vacuum seal film 251, in other embodiments the conveyors 241, 243 are not required and instead applied using machines which are hand loaded and unloaded to apply the vacuum seal film. FIG. 9A depicts an example embodiment of a tray 252 with the vacuum seal film 251 applied along the top of the tray 252 and the oysters 229 (e.g. meat 234 in the half shell 233) positioned in each compartment 258 after step 31.

In an embodiment, in step 33, the trays 252 from step 31 are stored in a container 270 in an inverted orientation. In one embodiment, FIGS. 9B-9C depict the trays 252 stored in the container 270 in the inverted orientation 277. The trays 252a, 252b are positioned in the container 270 in the inverted orientation 277 so that the vacuum seal films 251a, 251b of the trays 252a, 252b face a bottom 273 of the container 270 and/or are aligned with a direction of gravity 275 and/or are positioned more proximate to a gravitational core of the Earth than a bottom 262a, 262b of the trays 252a, 252b. Additionally, the vacuum seal 251a of a second tray 252a faces a bottom 262b of a first tray 252b. In another embodiment, in the inverted orientation 277, the bottom 262a, 262b of the trays 252a, 252b faces a top of the container 270 with an opening 272, where the trays 252a, 252b are inserted into the container 270 through the opening 272. In an example embodiment, the container 270 is configured to be oriented with the bottom 273 positioned below the top 271 during shipment of the container 270, with the bottom 273 positioned on a surface. In these embodiments, the oysters 229 within the container 270 are arranged in the inverted orientation since the meat 234 on the oysters 229 face the bottom 273 of the container 270 and/or the direction of gravity 275 whereas the shell 233 of the oysters 229 face the top 271 of the container 270 and/or a direction opposite to the direction of gravity 275. The inventor recognized that the inverted orientation 277 of the containers 270 preserves the oysters 229 by retaining the oysters 229 in their natural juices while not allowing the oysters 229 to lose moisture. As discussed below in the flowchart of FIG. 5B the oysters 229 are maintained in the inverted orientation during and after the thawing process.

Although FIGS. 9B-9C depict an embodiment of the inverted orientation 277 where the trays 252 are inserted into the container 270 in the inverted orientation 277, in another embodiment the oysters 229 are inserted into the compartments 258 in an inverted orientation with the meat 234 facing the bottom of the cavity 263 and the shell 233 facing the film 251 and the trays 252 are then inserted into the container 270 in an upright orientation (e.g. the film 251 facing the top 271 of the container 270 and the bottom 262 facing the bottom 273 of the container 270), as this arrangement would also result in the oysters 229 being arranged in the container 270 in the inverted orientation 277.

FIG. 9E depicts an embodiment of unfolded material 278 used to form the container 270 by folding it along the designated fold lines. The dimensions depicted in FIG. 9E are inches and are merely one example embodiment of the unfolded material 278 used to form the container 270.

As depicted in FIG. 9B, in one embodiment, a fixed number (e.g. a dozen) trays 252 are positioned in each container 270 in the inverted orientation 277 and the top 271 of the container 270 is then closed and sealed for shipment. In one embodiment, as depicted in FIG. 9F, in step 33 a plurality of containers 270a, 270b, 270c, 270d (e.g. 48 containers, with 6 per layer of 8 layers) are positioned in a pallet 280. In another example embodiment, refrigerant 282 encloses the containers 270 within the pallet 280 to maintain the containers 270 below a freezing temperature (e.g. about 0 degrees F. or in a range from about −32 degrees F. to about 32 degrees F.) during shipment. In other embodiments, after being packaged and palletized the containers 270 are stored at about 0 degrees F. in modern refrigerated commercial drive-in freezers for transport or shipment. In an embodiment, in step 33 the pallet 280 (or container 270) is shipped to a location (e.g. restaurant, hotel, etc.) where the oysters 229 are to be served. A method for processing the pallet 280 (or container 270) upon arrival at the location is discussed below in the flowchart of FIG. 5B.

FIG. 5B depicts a flowchart of a method 50 for serving oysters 229 from the assembly of FIG. 9F and/or from the pallet 280 and/or from the containers 270a, 270b, 270c, 270d and/or from the trays 252 within the container 270. In an embodiment, in step 52 the frozen oysters 229 are received at a receiving location (e.g. restaurant, hotel, etc.). In an embodiment, the receiving location is a location where oysters 229 are to be served (e.g. a restaurant, a hotel, etc.). In one embodiment, in step 52, the pallet 280 is received at the receiving location and the containers 270 are unpacked from the pallet 280 and/or the trays 252 are unpacked from each container 270. The pallet, containers 270, and trays 252 are positioned such that the oysters 229 maintain the inverted orientation 277.

In step 54, the oysters that are received at the location in step 52 are placed in a cooler such as a cold room 247 (FIG. 8A) to thaw the oysters 229. In one embodiment, the pallet 280 is positioned in the cold room 247. In other embodiments, each container 270 is removed from the pallet 280 and the containers 270 are positioned in the cold room 247. In yet other embodiments, the individual trays 252 are removed from the containers 270 and each tray 252 is positioned in the cold room 247. In step 54, the pallet 280, containers 270 and/or trays 252 are positioned in the cold room 247 so that the oysters 229 maintain the inverted orientation 277. In an embodiment, the cold room 247 has a thawing temperature that is greater than the freezing temperature (e.g. about 32 degrees F.) that the pallet 280 was shipped to the receiving location. In an example embodiment, the thawing temperature is about 45 degrees F. or in a range from about 32 degrees F. to about 55 degrees F. In step 54, the oysters 229 are stored at the thawing temperature (e.g. in the cold room 247) for a predetermined time so that the oysters 229 can thaw. In an example embodiment, the predetermined time is about 3-4 hours or in a range from about 2 hours to about 5 hours. In some embodiments, the predetermined time depends on the thawing temperature is less for higher thawing temperatures and higher for lower thawing temperatures.

In step 56, after the predetermined time in step 54 has elapsed and the oysters 229 are thawed, an order of a quantity of oysters 229 may be requested at the location (e.g. a customer at a restaurant at the location orders a quantity of oysters). In an embodiment, in step 56, one or more trays 252 of oysters 229 are removed from the cold room 247 and/or from the area with the thawing temperature. In some embodiments, the oysters 229 need not be removed from the cold room 247 during steps 58, 60, 62 and thus the removal of the oysters 229 from the cold room 247 in step 56 can be omitted. The number of trays 252 removed from the cold room 247 depend on the quantity of oysters 229 that were ordered. In an example embodiment, if the quantity of ordered oysters 229 is less than the fixed number of oysters 229 (e.g. a dozen) in each tray 252, then only one tray 252 is removed from the cold room 247. However, in another example embodiment, if the quantity of ordered oysters 229 is greater than the fixed number of oysters 229 in each tray 252 but less than double the number of oysters 229 in each tray 252, then two trays 252 are removed from the cold room 247.

In step 58, after removing the trays 252 from the cold room 247, the one or more trays 252 are oriented in an upright orientation on a surface so that the film 251 faces upward and the bottom 262 of the tray 252 faces downward and the bottom 262 is on the surface.

In step 60, the vacuum seal film 251 is then removed along the top of the tray 252 based on the ordered quantity of oysters 229. If the ordered quantity of oysters 229 is equal to or greater than the fixed number of oysters 229 in each tray 252, then the entire film 251 is removed in step 60. If the ordered quantity of oysters 229 is less than the fixed number of oysters 229 in each tray 252, then the film 251 is only removed in step 60 to the extent to expose the ordered quantity of oysters 229 in the tray 252.

In step 62, the exposed oysters 229 in the tray 252 are removed from the tray 252 after removing the film 251 in step 60. In one example embodiment, if the entire film 251 was removed in step 60, then the entire fixed number (e.g. a dozen) of oysters 229 are removed from the tray 252 in step 62. In another example embodiment, if the film 251 was only partially removed in step 60 to expose the ordered quantity of oysters (e.g. eight) that is less than the fixed number (e.g. dozen) of oysters 229 in the tray 252, then only the exposed ordered quantity of oysters are removed from the tray 252 in step 62.

In step 64, a determination is made whether oysters 229 remain in the tray 252 after step 62. In an embodiment, if any remaining oysters 229 are in the tray 252, the film 251 remains intact for those remaining oysters 229 since the film 251 was not removed for those oysters 229 in step 60. If remaining oysters remain in the tray 252, the method moves to step 66. If remaining oysters do not remain in the tray 252, the method moves to step 67.

In step 66, the tray 252 with some remaining oysters 229 with the intact film 251 providing the vacuum seal for those remaining oysters 229 is positioned back in the container 270 in the inverted orientation 277 in the cold room 247. Step 66 advantageously maintains that the remaining oysters 229 continue to soak in their natural juices and in the inverted orientation 277 until such time as they are served and thus prolong the freshness of the remaining oysters 229 in the tray 252.

In step 67, a determination is made about whether more oysters 229 are to be served at the location and whether a maximum time period (e.g. 72 hours) has elapsed since the oysters 229 were thawed in step 54. In an example embodiment, if the oysters 229 completed thawing in step 54 on t=0 hours (e.g. Friday at 10 am), then step 67 determines whether more oysters 229 are to be served and whether t>72 hours (e.g. whether it is after Monday at 10 am). The determination of whether more oysters 229 are to be served involves a determination of whether more orders of oysters are to be expected over the maximum time period (e.g. whether or not guests at a restaurant are expected to order oysters within the maximum time period). In some embodiments, the oysters 229 are not thawed in step 54 until a threshold order of oysters can be expected within the maximum threshold after step 54 (e.g. oysters 229 are not thawed in step 54 until Friday morning so to provide a 72 hour window to serve the oysters 229 in each of the trays 252 over the weekend, etc).

It is apparent in view of the teachings herein that an embodiment of the invention is particularly useful for producing frozen oysters on the half shell.

It will be understood that each of the steps described above, or two or more together, may also find a useful application in other types of constructions differing from the types described above.

While the invention has been illustrated and described as an embodiment of a method for producing oysters on the half shell, accordingly it is not limited to the details shown, since it will be understood that various omissions, modifications, substitutions and changes in the forms and details the device illustrated and its operation can be made by those skilled in the art without departing in any way from the sprint of the present invention. The teachings of all of the references cited herein are incorporated by reference to the extent not inconsistent with the teachings herein.

1. A method for packaging frozen oysters on a half shell in a container, wherein each frozen oyster on the half shell comprises oyster meat on a round shell, said method comprising the step of positioning the frozen oysters within the container in an inverted orientation such that oyster meat of the frozen oysters faces a bottom of the container and the round shell of the frozen oysters faces an opening in a top of the container.

2. The method according to claim 1, the positioning the frozen oysters within the container in the inverted orientation comprises:
positioning the frozen oysters in a tray such that the oyster meat of the frozen oysters faces an opening in a top of the tray and the round shell of the frozen oysters faces a bottom of the tray;
applying a vacuum seal along the top of the tray; and
positioning the tray in the container so that the vacuum seal along the top of the tray faces the bottom of the container and the bottom of the tray faces the opening in the top of the container.

3. The method according to claim 1, wherein the positioning the frozen oysters within the container in the inverted orientation comprises:
positioning the frozen oysters in a tray such that the round shell of the frozen oysters faces an opening in a top of the tray and the oyster meat of the frozen oysters faces a bottom of the tray;
applying a vacuum seal along the top of the tray; and
positioning the tray in the container so that the bottom of the tray faces the bottom of the container and the vacuum seal along the top of the tray faces the opening in the top of the container.

4. The method according to claim 2, wherein the tray includes a plurality of compartments and wherein the positioning the frozen oysters in the tray comprises positioning a respective frozen oyster in a respective compartment of the tray so that the oyster meat of the frozen oyster faces the opening in the top of the tray and the round shell of the oyster faces the bottom of the tray.

5. The method according to claim 2, wherein the vacuum seal comprises a film that is selected to have a thickness greater than a thickness threshold to prevent puncturing of the film by an edge of the half shell in the inverted orientation.

6. The method according to claim 5, wherein the thickness threshold is in a range from about 4 mil to about 8 mil.

7. The method according to claim 2,
wherein the positioning step comprises positioning the frozen oysters in a first tray and a second tray;
wherein the applying step comprises applying the vacuum seal along the top of the first tray and along the top of the second tray;
wherein the positioning step comprises positioning the first tray in the container so that the vacuum seal along the top of the first tray faces the bottom of the container and the bottom of the first tray faces the opening in the top of the container and the vacuum seal along the top of the second tray;
and wherein the positioning step further comprises positioning the second tray in the container so that the vacuum seal along the top of the second tray faces the bottom of the container and the bottom of the first tray and the bottom of the second tray faces the opening in the top of the container.

8. (canceled)

9. The method according to claim 2, wherein the applying the vacuum seal comprises:
positioning the tray containing the frozen oysters on a conveyor;
transporting the tray along the conveyor to a vacuum skin machine; and
applying a skin of the vacuum seal along the top of the tray with the vacuum seal device.

10. (canceled)

11. The method according to claim 1, wherein the frozen oysters are subjected to a glazing treatment before positioning the frozen oysters into the container.

12. The method according to claim 11, wherein the glazing treatment comprises applying a salt solution to the frozen oysters in a glazing tunnel using a spray nozzle, wherein the salt solution comprises between about 1 parts per million and about 50 parts per million of salt and water with a temperature in a range from about 30 degrees F. to about 40 degrees F.

13. The method according to claim 1, wherein the frozen oysters in the half shell are obtained by disengaging the oyster meat from a flat shell of the oyster so that the oyster meat remains on the round shell.

14. The method according to claim 13, wherein the frozen oysters in the half shell are obtained by one or more of:
freezing live oysters in their shells to produce frozen oysters, wherein the frozen oysters are unhinged;
subjecting the frozen oysters to a thermal shock treatment to produce thermal treated oysters, wherein said thermal shock treatment promotes disengagement of a portion of flesh of the oysters from one shell or both shells of the oysters; and
percussing the thermal treated oysters, so that at least one shell of the frozen oysters will be knocked off, thereby producing opened, frozen oysters in the half shell.

15. An assembly for packaging and transporting oysters on a half shell, wherein each frozen oyster on the half shell comprises oyster meat on a round shell, said assembly comprising:
a tray including a bottom and a top with a vacuum seal applied along the top of the tray to define a cavity between the bottom and the vacuum seal, wherein the cavity is configured to position the oysters on the half shell so that the oyster meat faces the vacuum seal and the half shell faces the bottom; and
a container including a bottom and a top, wherein the tray is positioned in the container with the vacuum seal facing the bottom of the container and the bottom of the tray facing the top of the container so to orient the oysters on the half shell in an inverted orientation within the container such that the oyster meat faces the bottom of the container and the half shell faces the opening in the top of the container.

16. The assembly according to claim 15, wherein the bottom of the container is positioned more proximate to the Earth's gravitational core than the top of the container during packaging and transport of the assembly.

17. (canceled)

18. The assembly according to claim 15, wherein the tray includes a plurality of compartments with dividers that separate adjacent compartments and wherein the compartments are individually sized to receive an individual oyster on the half shell.

19. The assembly according to claim 15, wherein the vacuum seal comprises a film with a thickness that is greater than a thickness threshold to prevent puncturing of the film by the oyster meat in the inverted orientation

20. (canceled)

21. The assembly according to claim 15, further comprising:
a first tray and a second tray, wherein the first tray and the second tray are each configured to position the oysters on the half shell in a respective cavity;
wherein the first tray is positioned in the container so that the vacuum seal along the top of the first tray faces the bottom of the container and the bottom of the first tray faces the top of the container and the vacuum seal along the top of the second tray;
and wherein the second tray is positioned in the container so that the vacuum seal along the top of the second tray faces the bottom of the container and the bottom of the first tray and bottom of the second tray faces the top of the container.

22. (canceled)

23. An assembly for packaging and transporting oysters on the half shell formed by the method of claim 2, wherein the assembly includes:
the container; and
a plurality of trays positioned in the container so that the frozen oysters in each tray are oriented in the inverted orientation within the container.

24. A method for serving oysters from the assembly of claim 15, comprising:
thawing the oysters by storing the assembly in a cooler at a thawing temperature for a predetermined time;
removing one or more trays from the container, after the predetermined time and when an amount of oysters are to be served;
orienting the one or more trays so that the oysters are in an upright orientation such that the oyster meat faces upward and the round shell faces downward;
removing the vacuum seal along the top of the tray to expose the amount of oysters to be served; and
removing the amount of oysters to be served from the tray.

25-27. (canceled)

28. The method according to claim 24, wherein the removing steps are performed within a maximum time period after the thawing step is performed, such that the oysters maintain freshness for the maximum time period after the thawing step and wherein the maximum time period is at least 24 hours.

29-30. (canceled)
